(19) United States
(12) Patent Application Publication
(10) Pub. No.: US 2011/0161294 A1
(43) Pub. Date: Jun. 30, 2011

(54) METHOD FOR DETERMINING WHETHER TO DYNAMICALLY REPLICATE DATA

(75) Inventors: David Vengerov, Santa Clara, CA (US); George Porter, San Diego, CA (US)

(73) Assignee: SUN MICROSYSTEMS, INC., Santa Clara, CA (US)

(21) Appl. No.: 12/649,466

(22) Filed: Dec. 30, 2009

(51) Int. Cl. G06F 17/30; G06N 5/02

(52) U.S. Cl. 707/637; 707/737; 706/54; 707/E17.017; 707/E17.046; 707/713; 707/E17.005

(57) ABSTRACT

The disclosed embodiments provide a system that determines whether to dynamically replicate data segments on a node in a computing cluster that stores a collection of data segments. During operation, the system identifies a data segment from the collection that is predicted to be frequently accessed by future tasks executing in the cluster. The system then determines a slowdown that would result for the current workload of the node if the data segment were to be replicated to the node. The system also determines a predicted future benefit that would be associated with replicating the data segment to the node. If the predicted slowdown is less than the predicted future benefit, the replication system replicates the data segment to the node.

### BACKGROUND

1. Field

This disclosure generally relates to techniques for managing data that is shared across a cluster of computing devices. More specifically, this disclosure relates to techniques for determining whether to dynamically replicate data segments on a computing device in a cluster of computing devices.

2. Related Art

The proliferation of the Internet and large data sets have made data centers and clusters of computers increasingly common. For instance, “server farms” typically group together large numbers of computers that are connected by high-speed networks to support services that exceed the capabilities of an individual computer. For example, a cluster of computers may collectively store satellite image data for a geographic area, and may service user requests for routes or images that are derived from this data.

However, efficiently managing data within such clusters can be challenging. For example, some data segments stored in a cluster may be accessed more frequently than other portions. This frequently accessed data can be replicated across multiple computing devices to prevent any one node from becoming a bottleneck. System designers often craft such optimizations manually or hand-partition data in an attempt to maintain high throughput despite such imbalances. However, variable loads and changing data sets can reduce the accuracy of such manual efforts over time. Hence, such clusters can eventually suffer from poor performance due to imbalances of data and/or tasks across the cluster.

Hence, what is needed are techniques for managing computer clusters without the above-described problems of existing techniques.

### SUMMARY

The disclosed embodiments provide a system that determines whether to dynamically replicate data segments on a node in a computing cluster that stores a collection of data segments. During operation, the system identifies a data segment from the collection that is predicted to be frequently accessed by future tasks executing in the cluster. The system then determines a slowdown that would result for the current workload of the node if the data segment were to be replicated to the node. The system also determines a predicted future benefit that would be associated with replicating the data segment on the node. If the predicted slowdown is less than the predicted future benefit, the replication system replicates the data segment on the node.

In some embodiments, the system determines high-demand data segments by tracking the data segments that are used by completed, executing, and queued tasks in the cluster.

In some embodiments, the system tracks demand for data segments using: a task scheduler for the cluster; a data manager for the cluster; an individual node in the cluster; and/or two or more nodes in the cluster working cooperatively.

In some embodiments, the system determines the slowdown and the predicted future benefit by correlating observed information from the cluster with task execution times.

In some embodiments, the system determines the predicted future benefit by comparing predicted task execution times when the data segment is stored locally with predicted execution times when the data segment is stored remotely.

In some embodiments, the system correlates observed information by: tracking information associated with tasks executed in the cluster; tracking information associated with the states of nodes in the cluster; and/or tracking information associated with network link usage and network transfers in the cluster.

In some embodiments, the system correlates observed information by tracking one or more of the following: the number of tasks currently executing on the node; the average expected execution time for each executing task on the node; the average expected slowdown of each executing task if the data segment were to be transferred to the node; the popularity of the data segment compared to other data segments stored by the node and/or cluster; and the average popularity of the data segments currently stored on the node.

In some embodiments, the system uses a state vector to track information for a parameterized cost function that facilitates determining the slowdown and predicted future benefit for replication decisions. During a given replication decision, the system uses values from the state vector as inputs to the parameterized cost function to predict whether replicating the data segment will lead to improved performance.

In some embodiments, the system uses feedback from observed states and task slowdowns to update the parameters of the parameterized cost function. Updating these parameters facilitates more accurately predicting the expected future slowdowns of tasks on the node.

In some embodiments, the system updates the parameters of the cost function using a closed-loop feedback learning approach based on reinforcement learning that facilitates adaptively replicating data segments on the node.

### BRIEF DESCRIPTION OF THE FIGURES

FIG. 1 illustrates an exemplary deployment of a computer cluster in accordance with an embodiment.

FIG. 2 illustrates dynamic replication of a data block between two nodes for the cluster computing environment of FIG. 1 in accordance with an embodiment.

FIG. 3 presents a flow chart illustrating the process of determining whether to dynamically replicate data segments on a compute node in a computing cluster that stores a collection of data segments in accordance with an embodiment.

FIG. 4 illustrates a computing environment in accordance with an embodiment of the present invention.

FIG. 5 illustrates a computing device that includes a processor with replication structures that support determining whether to dynamically replicate data in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

### Cluster Computing Environments

Clusters of computers can be configured to work together closely to support large-scale (e.g., highly scalable and/or high-availability) applications. For instance, a cluster of computers may collectively provide a persistent storage repository for a set of data, and then work collectively to service queries upon that data set. In such environments, a large number of queries may operate upon a “stable” (e.g., mostly unchanging, or changing in small increments over time) data set, in which case the majority of the data stored in the cluster remains persistent for some time. However, different portions of this data set may experience different levels of popularity over time. For instance, different sections of a geographic data set may receive higher query traffic during certain seasons or times of day.

The resources of a computer cluster may be logically structured into a range of system organizations. For instance, one cluster deployment, called the Hadoop Map/Reduce deployment, consists of two primary layers: 1) a data storage layer (called the Hadoop Distributed File System, or HDFS), and 2) a computation layer called Map/Reduce. Typically, in such a deployment, a single compute node in the cluster serves both as a file system master (or “NameNode”) and as a task coordinator (also referred to as a “Map/Reduce coordinator” or “JobTracker”). The other computing devices in the deployment may run: 1) one or more “DataNode” processes that store and manage a portion of the distributed file system, and/or 2) one or more “TaskTracker” processes that perform the tasks associated with user-submitted queries. Note that, while some of the following examples are described in the context of a Hadoop Map/Reduce cluster deployment, the described techniques can be applied to any cluster computing environment in which persistent data is partitioned and stored across multiple computers.

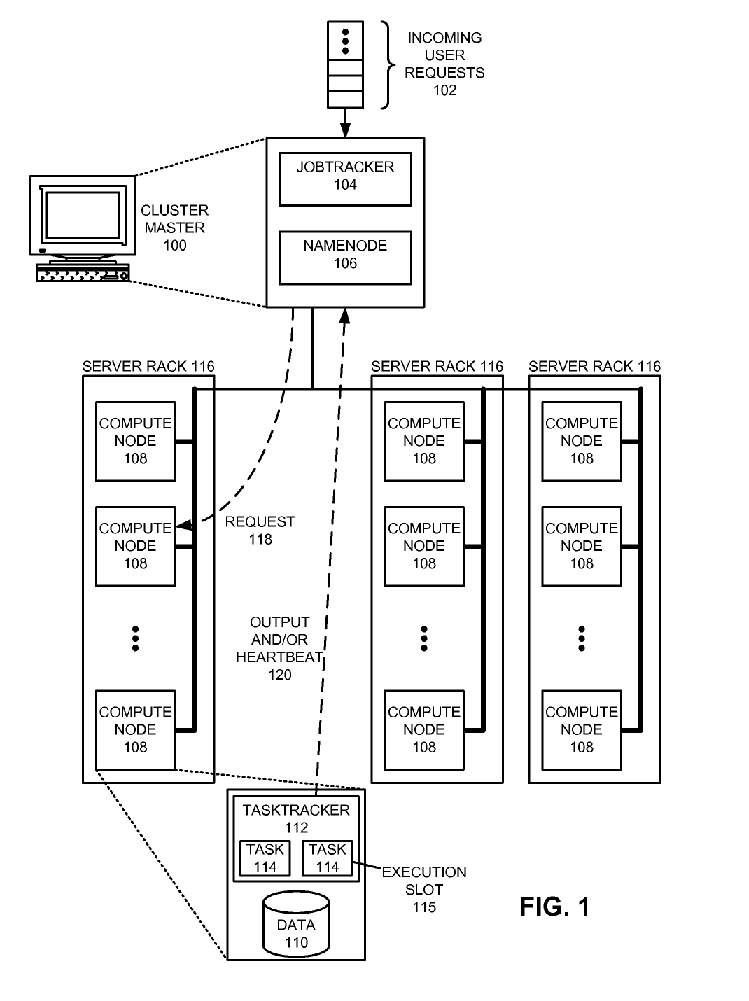

FIG. 1 illustrates an exemplary deployment of a computer cluster. During operation, incoming user requests 102 are received by the cluster master 100. A JobTracker process 104 in cluster master 100 receives user requests 102, and forwards information for such requests to cluster compute nodes 108. A NameNode task 106 in cluster master 100 tracks and manages the state of a data set that is distributed across compute nodes 108. Each compute node stores a subset of data 110 from this data set and supports one or more TaskTracker processes 112 that track one or more tasks 114 that operate on data 110. Compute nodes 108 may be connected using a range of network architectures. For instance, in some deployments, computers in a data center may be grouped into sets of server racks 116, where each server rack 116 holds a set of compute nodes 108 that are connected by a high-capacity network that offers full connectivity and low latency. The server racks 116 and cluster master 100 are also connected by network links. Note, however, that communication between server racks 116 may be slower than intra-rack traffic, due to longer, shared network links that have lower bandwidth and higher latency.

In some embodiments, tasks submitted to the cluster consist of a “map function” M and a “reduce function” R. More specifically, a map function M indicates how an input can be chopped up into smaller sub-problems (that can each be distributed to a separate compute node 108), and a reduce function R indicates how the results from each of the sub-problems can be combined into a final output result. JobTracker 104 can break a user request into a set of one or more map and reduce tasks, where each map task has the same map function M, and each reduce task has the same reduce function R. Individual map tasks executing on each respective compute node 108 are differentiated based on the input data they process (e.g., each map task takes a different portion of the distributed data set as input).

In some embodiments, TaskTracker process 112 may include a fixed number of map and reduce execution slots 115 (e.g., a default of two slots of each type), with each slot able to run one task of the appropriate type at a time. A slot currently executing a task is considered “busy,” while an idle slot awaiting a new task request 118 is considered “free.” TaskTracker process 112 sends output for completed requests 120 back to cluster master 100. TaskTracker process 112 may also be configured to send periodic heartbeat messages to JobTracker 104 to indicate that the associated compute node 108 is still alive and to update JobTracker 104 of task status. Such heartbeat messages can be used to indicate that a slot is free, in which case JobTracker 104 can select an additional task to run in the free slot.

In some embodiments, a data set stored by the cluster may be broken into a set of regularly sized blocks that are distributed, and perhaps replicated, across the compute nodes of the cluster. For instance, one data organization may split a data set into blocks that are 64, 128, and/or 256 MB in size, and may be distributed within a data center or geographically across multiple data centers. NameNode 106 maintains a mapping for the set of blocks in the data set, and tracks which blocks are stored on each specific compute node. The compute nodes may also be configured to periodically send a list of the data blocks they are hosting to the NameNode.

As mentioned above, data blocks may be replicated across multiple compute nodes. Such replication can ensure both that the computing capacity of a single compute node does not become a bottleneck for a popular data block and that a crash in a compute node does not result in data loss or substantial delay. For instance, a data set may be associated with a replication factor K, in which case the NameNode may direct a client writing blocks of data to the file system to replicate those blocks to a group of K compute nodes in the cluster. In one implementation, the client may send the blocks to a first compute node in the group along with instructions to forward the data blocks to the other compute nodes in the group. Hence, each of the K compute nodes may be configured to recursively pipeline the data blocks to another compute node in the group until all group members have received and stored the specified data.

Note, however, that for many cluster deployments data replication is managed manually and configured primarily at the time of initialization. For instance, for an HDFS, an administrator typically needs to set a replication factor during initialization that specifies the number of copies that will be stored for all data blocks (or, if unspecified, the system otherwise defaults to a replication factor of 3). Furthermore, the system does not differentiate the level of replication for blocks of different popularity, and the level of replication does not change at run time.

Note also that the actual replication factor for a given block may sometimes differ from a configured replication factor. When a computing node fails, any blocks located on that node machine are lost, thereby effectively reducing the actual replication factor for those blocks. If the replication factor for a given block falls below the target replication factor, a NameNode may instruct one of the nodes currently holding a copy of the block to replicate the block to another node. If the failed node is restored, the additional copy may temporarily result in a temporarily higher replication factor for the replicated block. If the replication factor for a block is above the specified target, the NameNode can instruct an appropriate number of compute nodes to delete their respective copies.

In some embodiments, a scheduling component in the cluster attempts to schedule tasks onto compute nodes (or at least server racks) that already store the data needed for those tasks, thereby saving the hosts for such tasks from needing to perform a network transfer to acquire the needed data prior to execution. A task that accesses data located on the same node will typically execute faster than a task that needs to access data located on a remote note, because of the network transfer latency. The average execution speed of submitted tasks may improve significantly if larger replication factors are used for frequently accessed data blocks to minimize the task delay associated with reading these data blocks from remote nodes.

However, balancing a beneficial level of replication across nodes over time and changing workloads without interfering with the progress of existing executing tasks is challenging. For instance, if an existing task is reading data from a remote node, a replication operation may increase the network delay experienced by the task and negatively impact the overall average execution speed. Unfortunately, existing replication techniques are typically manual, and involve sets of fixed rules that designers hope will perform well but are often not evaluated or updated over time. Furthermore, such techniques typically do not contrast the potential speed-up of future tasks that arises from replicating additional copies of data blocks with the potential slowdown for currently running tasks that can be caused by data replication operations.

Embodiments of the present invention involve replication techniques that strive to optimize cluster performance over time by finding an optimal balance between current performance and future performance. The described adaptive techniques facilitate identifying and dynamically replicating frequently used data blocks in cluster environments to reduce average task execution times.

### Dynamically Replicating Data Blocks in Cluster Computing Environments

A replication policy for a computer cluster needs to consider a range of factors, including: current bandwidth usage on network links that would be used for data replication (e.g., to ensure that opportunistic data replication does not substantially interfere with other tasks also using network bandwidth); current storage usage (e.g., to ensure that compute nodes do not to run out of storage space); and expected future demand for each data block. Because such factors typically cannot be anticipated in advance, an adaptive replication policy needs to evolve based on the types and characteristics of tasks that are submitted to the cluster. Determining beneficial trade-offs for such factors often depends on the tasks that are currently being executed in a computer cluster, the tasks that are currently queued for execution, and the tasks that will be submitted in the future.

Embodiments of the present invention involve trading off current performance for future benefit when dynamically replicating data blocks across a cluster of compute nodes. The described techniques observe cluster workload and execution trends over time, and then use the observed information to tune a set of replication parameters that improve the quality of data replication decisions and, hence, improve performance for the cluster environment.

In some embodiments, the cluster tracks which data blocks are expected to be in a greatest demand by future tasks. For instance, the cluster may continually track which data blocks were accessed by the greatest number of recently executed, executing and/or queued tasks, and then use this tracking information to predict which data blocks are expected to be most commonly accessed in the near future. Note that such tracking may be performed by a number of entities in the cluster, including one or more of the following: a task schedule for the cluster; a data manager for the cluster; an individual node in the cluster; and two or more nodes in the cluster that work cooperatively. For example, a scheduling component in a cluster-managing node may be well-situated to observe the set of data blocks needed by new tasks being submitted to the cluster. The scheduler can use these observations to compile a list of data block usage and/or popularity that can be sent to compute nodes in the cluster either proactively or on-demand.

In some embodiments, each computing node independently decides whether or not acquiring and replicating popular data blocks would be locally beneficial to future performance. For instance, a node may calculate a predicted future benefit associated with replicating a popular data segment. Having a popular block already available locally saves time over an on-demand transfer (which requires a task to wait until sufficient data has been streamed from a remote node to allow execution to begin), and increasing the number of nodes storing popular blocks can also reduce the queuing delay for tasks that need to access such blocks. The node can compare such benefits to a predicted slowdown that would occur for tasks currently executing on the node if such a replication operation were to occur. For example, if one or more local tasks are processing remote data that needs to be transferred to the node via a network link, consuming additional network bandwidth to replicate a popular data block will take network resources away from the currently executing tasks, thereby causing additional delay. However, if additional network bandwidth is available, or the predicted speed-up associated with the replication operation is substantial enough, the node may decide that the replication operation is worthwhile and proceed.

Compute nodes in the cluster are typically connected using full duplex network links. Thus, because the outgoing network bandwidth for a compute node is independent from the incoming network bandwidth, streaming data out from a source node typically involves little network delay or contention for the source node (unless the task results being output by the compute node require substantial bandwidth). However, as mentioned above, the receiving node may be streaming in remote data needed for tasks; therefore, splitting the incoming (downstream) network bandwidth for a compute node may delay executing tasks. Hence, the benefits of opportunistic replication are often clearer when the incoming network bandwidth for a compute node is currently unused or only lightly used. In some embodiments, compute nodes delay replicating popular data blocks until downstream bandwidth is below a specified threshold (e.g., until downstream bandwidth is unused, or below 10% of capacity).

Note, however, that replication decisions may also need to consider task processing characteristics. For instance, if task processing tends to be slower than network transfers (e.g., each task performs a large amount of computation on relatively small pieces of data), using a portion of a node's network link for replication may not adversely affect the bandwidth being used by a task operating upon remote data. Task processing and network usage may need to be considered in the process of deciding whether a replication operation will have an adverse or beneficial impact.

In general, fixed rules may be used to motivate clearly beneficial replication operations. However, while such fixed rules may provide benefits, they may also miss additional replication operations that could further improve cluster performance. Hence, making accurate and beneficial replication operations may involve more elaborate efforts that correlate observable information with observed task-execution information to more accurately predict task-execution times for both local and remote data.

In some embodiments, a compute node may consider one or more of the following factors when calculating potential future benefits or slowdowns associated with a potential replication operation:
the number of tasks currently running on the node;
the average expected execution time for each of the running tasks (e.g., calculated by performing a regression on past task-execution times as a function of the size of the data processed by each task and whether that data was local or remote);
the average expected slowdown for each local task if an additional replication operation were to take place (e.g., supposing an additional replication operation, 1) calculating the resulting bandwidth that will be available to currently executing tasks, and 2) extending the tasks' execution time by multiplying a ratio of the original available bandwidth to the updated bandwidth with the fraction of each task that remains to be completed);
the popularity of data blocks stored on the node (e.g., calculating the average popularity of the data blocks currently present on the node and/or the fraction of the top N most popular blocks present on the node before and/or after the replication operation);
the popularity of the data block(s) being considered for replication (which can, for instance, be estimated based on the fraction of queued, executing, and/or recently executed tasks that use(d) the data block); and
the size of the data block(s) being considered for replication and the additional delay that an executing task would have if it had to transfer the file from a remote node.
   Note that the above factors are merely representative, and that a wide range of factors and observable information about the state of one or more compute nodes, tasks in the cluster (or an individual node), and network characteristics may be tracked and considered when determining an expected slowdown and a potential future benefit associated with a replication decision. Basing such decisions on relevant metrics that are closely correlated with recent task-execution times facilitates making replication choices that will improve the overall performance of the cluster.

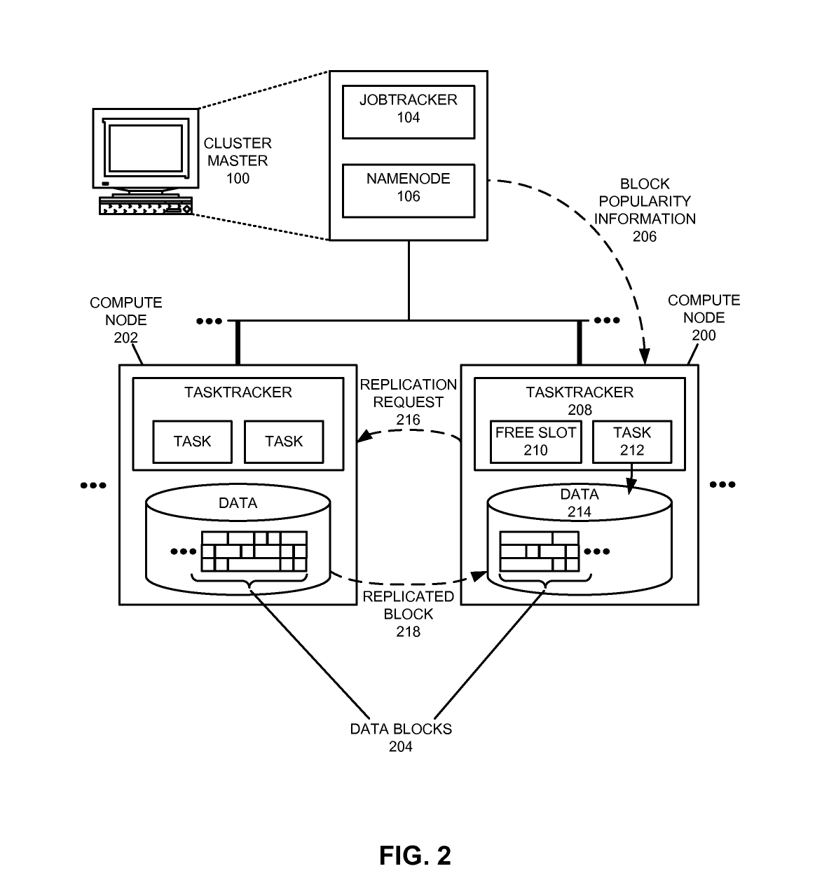

FIG. 2 illustrates dynamic replication of a data block between two compute nodes for the cluster computing environment of FIG. 1. In FIG. 2, compute node 200 and compute node 202 collectively store a set of data blocks 204 (where some data blocks may be simultaneously stored on both nodes, depending on historical task execution and data needs for the two nodes). Cluster master 100 tracks demand for data blocks, and forwards block popularity information 206 to compute node 200. During operation, compute node 200 considers whether to replicate a data block that is indicated to be highly in-demand by block popularity information 206. Compute node 200 may predict a slowdown associated with replicating such a popular data block, and compare this slowdown to a predicted future benefit of storing the popular data block. For instance, FIG. 2 illustrates a scenario where TaskTracker 208 for compute node 200 determines that one execution slot is currently free 210, and that the task 212 in a second slot is executing using locally stored data 214. In this scenario, the downstream network bandwidth for compute node 200 is currently unused, and hence the predicted slowdown associated with replicating a popular data block should be relatively low. As a result, compute node 200 is likely to replicate the popular data block. Compute node 200 proceeds to find another node hosting the popular block (e.g., using information included in block popularity information 206, or by sending an additional look-up request to cluster master 100), and then sends a replication request 216 to that other node (e.g., compute node 202). The other compute node 202 responds to the request by sending the replicated block 218 to compute node 200.

Note that in an alternative scenario where two or more local tasks were executing on compute node 200 using remote data (that was streaming in from other compute nodes), the predicted slowdown associated with replication might outweigh the predicted future benefit, and hence compute node 200 might instead choose to not replicate the block in the current timeframe.

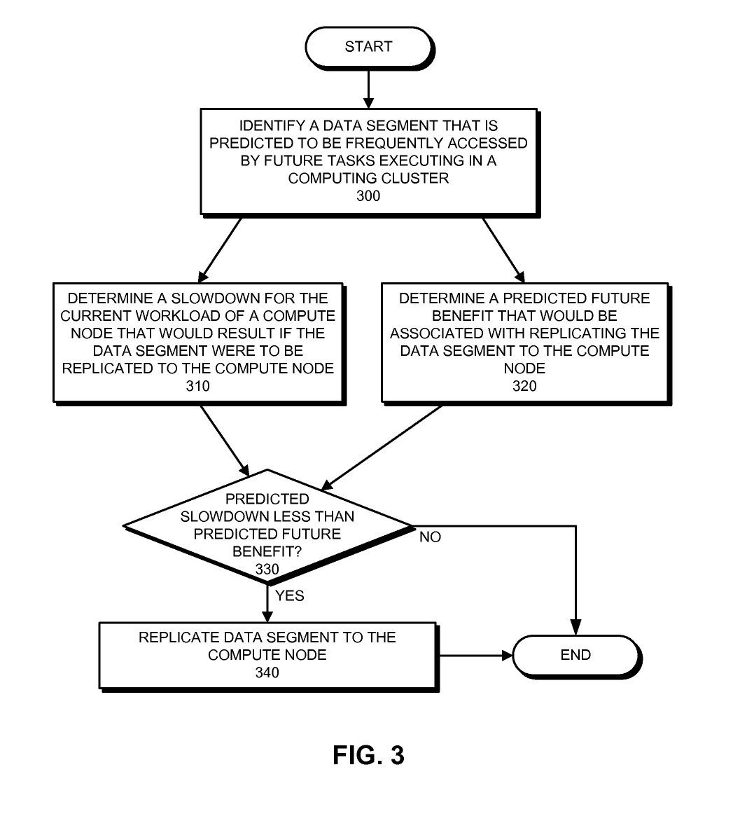

FIG. 3 presents a flow chart that illustrates the process of determining whether to dynamically replicate data segments on a compute node in a computing cluster that stores a collection of data segments. During operation, a replication system on the computing device identifies a data segment from the collection that is predicted to be frequently accessed by future tasks executing in the cluster (operation 300). The replication system then determines a slowdown that would result for the current workload of the compute node if the data segment were to be replicated to the compute node (operation 310). The replication system also determines a predicted future benefit that would be associated with replicating the data segment on the compute node (operation 320). If the predicted slowdown is less than the predicted future benefit (operation 330), the replication system replicates the data segment to the compute node (operation 340); otherwise, the process ends.

Note that, as mentioned above, having a popular block already replicated locally saves time for the next task on that node that actually uses the block. Knowing the popularity of the data block may prevent the block from being discarded by a local block replacement strategy, thereby saving additional time for other future tasks that use the popular data block. For instance, in a cluster that does not track the overall demand for data blocks, a node receiving a data block needed for a local task may choose to discard that data block immediately, or may cache the data block for a longer time (e.g., following a most-recently-used block replacement strategy at the node level). However, such a local (node) cache policy that does not consider block popularity may discard a popular block, only to have the block need to be loaded again in the near future. In contrast, the described techniques can incorporate data eviction techniques that consider cluster-level block popularity, thereby improving performance by saving network transfer time not only in the first instance where a popular block would need to be transferred, but also in subsequent instances (where other techniques might have already discarded the block). For example, compute nodes may be configured to only evict data blocks below a specified level of popularity.

Opportunistically replicating data across a cluster of computing devices increases the average popularity of the blocks on nodes, thereby increasing the probability that a new task entering the cluster will find a needed data segment on a node, and improving performance of tasks accessing data segments. The above-described techniques and factors can be incorporated to improve the set of replication decisions made by computing nodes in the cluster. However, because a number of the factors depend upon expected values and probabilities, there is still a chance that non-optimal replication decisions may be made. Hence, the system may benefit from a self-tuning strategy that identifies beneficial rules for different workload contexts and uses this information to more accurately predict task-execution times and replication effects.

### Dynamic Replication Using Feedback Learning

Some embodiments use “closed-loop” feedback learning to dynamically tune a replication policy that decides whether or not to initiate the opportunistic replication of some data blocks based on currently observed information. For instance, each node can maintain and dynamically adjust (“learn”) a parameterized cost function which predicts average expected future slowdown relative to a more basic scenario where data required by each task resides locally on the node. Each node compiles observed data and trends into a state vector, where each component of the state vector can be used as an input variable to the cost function to perform a calculation for a given replication decision. Note that the state vector changes automatically over time as the values of tracked information variables change. By adopting a set of adaptive calculations (instead of using fixed rules that are based on thresholds and importance values), the described system can make more accurate and beneficial replication decisions.

The following paragraphs describe an exemplary closed-loop feedback learning approach that uses reinforcement learning to adaptively replicate data segments. However, a wide range of other feedback learning approaches may also be used to tune a compute node's replication policy.

In some embodiments, each compute node i in the computer cluster learns its own cost function Cᵢ(x), which predicts the expected average future slowdown (relative to a base case in which the data required by each task resides locally on the node) of all tasks completed on that node starting from the state vector x. The state vector encodes the relevant information needed for making such a prediction, and thus improving the accuracy and completeness of state vector x improves the potential prediction accuracy of the cost function Cᵢ(x). An exemplary state vector that is well correlated with future task slowdown and benefit considers (but is not limited to) the list of factors that were described in the previous section.

Each node can independently tune its own set of parameters for the cost function Cᵢ(x) by observing task and network operations and using reinforcement learning. For instance, each node may start with a training phase during which the behavior of any default file replication policy is observed to tune an initial set of parameters for Cᵢ(x). To choose a file replication decision at time t, the node first computes state vector x and a starting value C₀=Cᵢ(x). Next, the node determines the set of possible file replication decisions, and for each decision d, a new state vector y_{d} is computed that will arise if decision d is implemented. Then, the node computes a best new cost value,

$${C}^{*} = {min}_{d} {C}_{i} ( {y}_{d} ) ,$$

and records the corresponding decision

$${d}^{*} = {argmin}_{d} {C}_{i} ( {y}_{d} ) .$$

If C*<<C₀, then the node implements file replication decision d*. Otherwise, the node does not perform a replication operation at time t. The node correlates information associated with the different observed states and decisions into the state vector on an ongoing basis, thereby learning (and tuning) over time the set of slowdowns (and benefits) that are likely for very specific scenarios. This information is used, and tuned, in each successive cost calculation (e.g., by finding a state in the state vector that matches the conditions for a given replication decision, and then using the values associated with that state as inputs for the cost function during that decision). If a subsequent observation for a replication decision differs from the prediction, information associated with the error is propagated back into the cost function as feedback (e.g., the errors in forecasts of task slowdowns in observed states are used to tune the parameters of the cost function to reduce future errors in future states). The accuracy of the calculations increases as more states are sampled, thereby leading to increasing accuracy in both the feedback loop and the set of replication decisions.

For example, consider a simple cost function of the form F(x)=a₁x₁+a₂x₂, where a₁ and a₂ are parameters that are embedded into the cost function, and where x₁ and x₂ are state variables that are used as the inputs to the cost function. For instance, x₁ and x₂ may be associated with the number of tasks on the node and the average expected execution time of these tasks, respectively. During operation, as new tasks are scheduled, the input values for x₁ and x₂ change depending on tracked information in the state vector. The parameters a₁ and a₂ are changed only when the feedback learning algorithm is enabled (e.g., when performing tuning after detecting an error in a forecast of a task slowdown).

In some embodiments, an exemplary cost function for each node follows the form:

$$\hat{C} ( x , p ) = {\sum }_{k = 1}^{N} {p}^{k} {φ}^{k} ( x ) ,$$

where φ^{k}(x) are fixed, non-negative basis functions defined on the space of possible values of x, and p^{k} (where k=1 . . . , N) are the tunable parameters that are adjusted in the course of learning. A cost function of this form, which is linear in the tunable parameters, can be readily implemented and easily and robustly adjusted using a wide range of feedback learning schemes.

In some embodiments, the node may update the parameters for a cost function using a “back-propagation” technique that computes for each step the partial derivative of the observed squared error with respect to each parameter, and then adjusts each parameter in the direction that minimizes the squared error:

$$\begin{matrix}{p}_{t + 1}^{i} = {p}_{t}^{i} + {α}_{t} \frac{\partial }{\partial {p}^{i}} {( {c}_{t} + γ \hat{C} ( {x}_{t + 1} , {p}_{t} ) - \hat{C} ( {x}_{t} , {p}_{t} ) )}^{2} \\ = {p}_{t}^{i} + {α}_{t} ( {c}_{t} + γ \hat{C} ( {x}_{t + 1} ) - \hat{C} ( {x}_{t} ) ) \frac{\partial }{\partial {p}^{i}} \hat{C} ( {x}_{t} , {p}_{t} ) \\ = {p}_{t}^{i} + {α}_{t} ( {c}_{t} + γ \hat{C} ( {x}_{t + 1} ) - \hat{C} ( {x}_{t} ) ) {φ}^{i} ( {x}_{t} ) ,\end{matrix}$$

where αₜ is a learning rate that is usually set to αₜ=1/t, pₜⁱ refers to the value of the parameter pⁱ at time t during the learning phase, cₜ is the feedback signal received at time t (e.g., in this case, this will be the average percentage slowdown of tasks completed on the node between time steps t and t+1), and γ is a discounting factor between 0 and 1 (where a 0.9 often works well in practice).

Note that, in situations where a cost function describes a stable process and the desired goal is to converge to an optimal value, a node could keep reducing the learning rate (thereby diminishing parameter changes over time). However, because the described techniques call for ongoing adaptability over time as the cluster workload and data set changes, some embodiments set a lower bound on the learning rate that ensures that the parameters of the cost functions will continue to be updated in a manner that minimizes the most recently observed difference between expectations for the near future (as computed by Ĉₜ(xₜ,pₜ)) and the actual outcome (as computed by cₜ+γĈₜ(xₜ₊₁,pₜ)). Hence, the calculations can continue to offer beneficial predictions even if the probability distributions of all random quantities keep changing over time in a non-stationary multi-agent environment.

Note that the described replication systems can use reinforcement learning approaches other than the above-described Cᵢ(x) cost functions. For example, each node could specify a parameterized policy Fᵢ(x) that maps the above-described input vector x (where each vector is derived by assuming a particular file replication decision) into the probability of making the corresponding file replication decision. Parameters of the policies Fᵢ(x) can be tuned using gradient-based reinforcement learning. Such a reinforcement learning approach can also work well in a non-stationary multi-agent environment, thereby leading to learned policies that are superior to non-adaptive policies.

In some embodiments, each compute node in the cluster independently maintains a separate set of decision data that it uses to make replication decisions. Maintaining such data separately allows each node to separately decide whether or not it wants to acquire a popular data segment, by comparing the potential slowdown for currently executing tasks and the potential speed-up of future tasks. In some alternative embodiments, compute nodes can share learning information with each other, thereby increasing the speed with which the state vector grows and adapts to changing. Because learning can scale nearly linearly with the number of nodes sharing learning information, such sharing can significantly improve the quality of replication decisions that are made by the cluster. Note that the shared learning data may need to be normalized (or otherwise weighted) to account for nodes with different computing power and/or network bandwidth.

Note that the described techniques assume that, while the persistent data set may change over time, past access patterns and execution times are likely to remain substantially similar in the near future (e.g., recently popular data is likely to be accessed again). The inferences made by a dynamic replication system may be less beneficial if data or access patterns change randomly and/or in short time intervals. In such scenarios, the described techniques may be adjusted, for instance to weigh the slowdown associated with replication more heavily or even to temporarily disable dynamic replication until beneficial inferences become possible again.

In summary, embodiments of the present invention facilitate determining whether to dynamically replicate data in a computing cluster. The described system continually identifies the data segments that are expected to be in the greatest demand in the cluster. Each node in the cluster uses this demand information and a parameterized cost function to independently determine whether a given replication decision will result in a predicted slowdown or benefit, and decides accordingly. Nodes observe the performance impacts of these decisions, and use this feedback to further tune the parameters for their cost function over time. By ensuring that the blocks stored on each computing node are more likely to be beneficial, the described system reduces the average time spent waiting for data blocks to be transferred over the network, and thus increases the average execution speed of tasks that are submitted to the cluster.

### Computing Environment

In some embodiments of the present invention, techniques for dynamically replicating data segments can be incorporated into a wide range of computing devices in a computing environment.

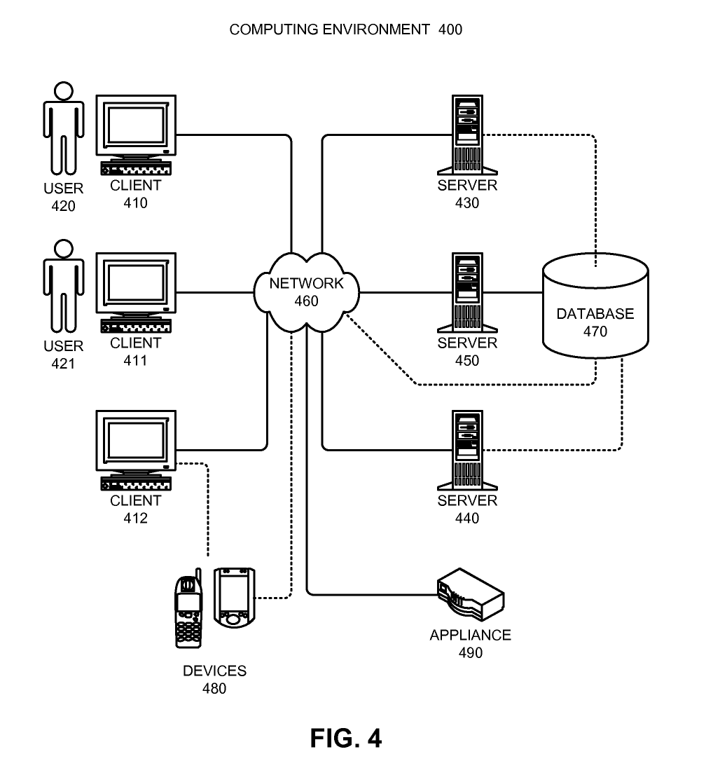

FIG. 4 illustrates a computing environment 400 in accordance with an embodiment of the present invention. Computing environment 400 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 4, computing environment 400 includes clients 410-412, users 420 and 421, servers 430-450, network 460, database 470, devices 480, and appliance 490.

Clients 410-412 can include any node on a network that includes computational capability and includes a mechanism for communicating across the network. Additionally, clients 410-412 may comprise a tier in an n-tier application architecture, wherein clients 410-412 perform as servers (servicing requests from lower tiers or users), and wherein clients 410-412 perform as clients (forwarding the requests to a higher tier).

Similarly, servers 430-450 can generally include any node on a network including a mechanism for servicing requests from a client for computational and/or data storage resources. Servers 430-450 can participate in an advanced computing cluster, or can act as stand-alone servers. For instance, computing environment 400 can include a large number of compute nodes that are organized into a computing cluster and/or server farm. In one embodiment of the present invention, server 440 is an online “hot spare” of server 450.

Users 420 and 421 can include: an individual; a group of individuals; an organization; a group of organizations; a computing system; a group of computing systems; or any other entity that can interact with computing environment 400.

Network 460 can include any type of wired or wireless communication channel capable of coupling together computing nodes. This includes, but is not limited to, a local area network, a wide area network, or a combination of networks. In one embodiment of the present invention, network 460 includes the Internet. In some embodiments of the present invention, network 460 includes phone and cellular phone networks.

Database 470 can include any type of system for storing data in non-volatile storage. This includes, but is not limited to, systems based upon magnetic, optical, or magneto-optical storage devices, as well as storage devices based on flash memory and/or battery-backed up memory. Note that database 470 can be coupled: to a server (such as server 450), to a client, or directly to a network. In some embodiments of the present invention, database 470 is used to store information related to virtual machines and/or guest programs. Alternatively, other entities in computing environment 400 may also store such data (e.g., servers 430-450).

Devices 480 can include any type of electronic device that can be coupled to a client, such as client 412. This includes, but is not limited to, cell phones, personal digital assistants (PDAs), smart-phones, personal music players (such as MP3 players), gaming systems, digital cameras, portable storage media, or any other device that can be coupled to the client. Note that, in some embodiments of the present invention, devices 480 can be coupled directly to network 460 and can function in the same manner as clients 410-412.

Appliance 490 can include any type of appliance that can be coupled to network 460. This includes, but is not limited to, routers, switches, load balancers, network accelerators, and specialty processors. Appliance 490 may act as a gateway, a proxy, or a translator between server 440 and network 460.

Note that different embodiments of the present invention may use different system configurations, and are not limited to the system configuration illustrated in computing environment 400. In general, any device that is capable of storing and/or dynamically replicating data segments may incorporate elements of the present invention.

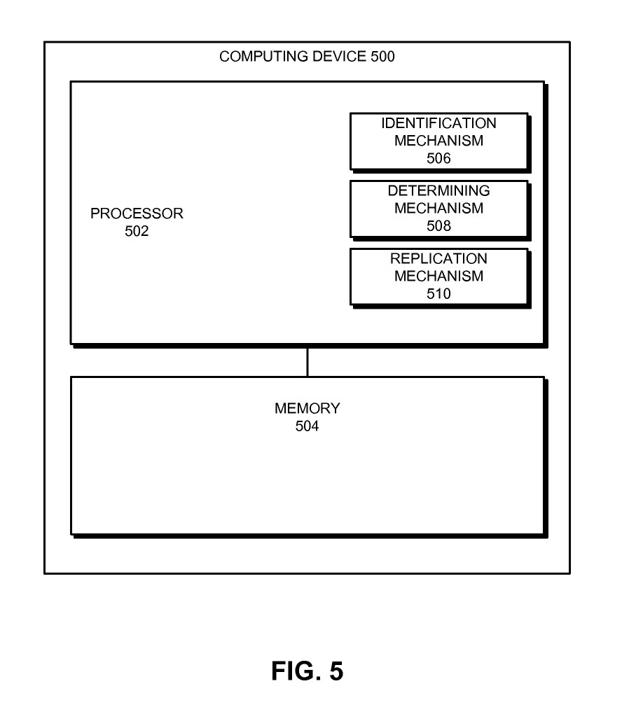

FIG. 5 illustrates a computing device 500 that includes a processor 502 and memory 504. Computing device 500 operates as a node in a cluster of computing devices that collectively stores a collection of data segments. Processor 502 uses identification mechanism 506, determining mechanism 508, and replication mechanism 510 to determine whether to dynamically replicate data segments from the collection.

During operation, processor 502 uses identification mechanism 506 to identify a data segment from the collection of data segments that is predicted to be frequently accessed by future tasks executing in the cluster. Processor 502 then uses determining mechanism 508 to determine a slowdown that would result for the current workload of the computing device 500 if the data segment were to be replicated to computing device 500. Determining mechanism 508 also determines a predicted future benefit that would be associated with replicating the data segment on computing device 500. If the predicted slowdown is less than the predicted future benefit, replication mechanism 510 replicates the data segment on computing device 500.

In some embodiments of the present invention, some or all aspects of identification mechanism 506, determining mechanism 508, and/or replication mechanism 510 can be implemented as dedicated hardware modules in processor 502. For example, processor 502 can include one or more specialized circuits for performing the operations of the mechanisms. Alternatively, some or all of the operations of identification mechanism 506, determining mechanism 508, and/or replication mechanism 510 may be performed using general-purpose circuits in processor 502 that are configured using processor instructions.

Although FIG. 5 illustrates identification mechanism 506, determining mechanism 508, and replication mechanism 510 as being included in processor 502, in alternative embodiments some or all of these mechanisms are external to processor 502. For instance, these mechanisms may be incorporated into hardware modules external to processor 502. These hardware modules can include, but are not limited to, processor chips, application-specific integrated circuit (ASIC) chips, field-programmable gate arrays (FPGAs), memory chips, and other programmable-logic devices now known or later developed.

In these embodiments, when the external hardware modules are activated, the hardware modules perform the methods and processes included within the hardware modules. For example, in some embodiments of the present invention, the hardware module includes one or more dedicated circuits for performing the operations described below. As another example, in some embodiments of the present invention, the hardware module is a general-purpose computational circuit (e.g., a microprocessor or an ASIC), and when the hardware module is activated, the hardware module executes program code (e.g., BIOS, firmware, etc.) that configures the general-purpose circuits to perform the operations described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for determining whether to dynamically replicate data segments on a computing device, wherein the computing device operates as a node in a cluster of computing devices that collectively stores a collection of data segments, comprising:
identifying a data segment from the collection that is predicted to be frequently accessed by future tasks executing in the cluster;
determining a slowdown that would result for the current workload of the node if the data segment were to be replicated to the node;
determining a predicted future benefit associated with replicating the data segment to the node; and
replicating the data segment to the node when the slowdown is less than the predicted future benefit.

2. The method of claim 1, wherein identifying the data segment comprises determining high-demand data segments by tracking the data segments that are used by completed, executing, and queued tasks in the cluster.

3. The method of claim 2, wherein demand for data segments is tracked by one or more of the following:
a task scheduler for the cluster;
a data manager for the cluster;
an individual node in the cluster; and
two or more nodes in the cluster working cooperatively.

4. The method of claim 1, wherein determining the slowdown and the predicted future benefit comprises correlating observed information from the cluster with task-execution times.

5. The method of claim 4, wherein determining the predicted future benefit involves comparing predicted task-execution times when the data segment is stored locally with predicted execution times when the data segment is stored remotely.

6. The method of claim 4, wherein correlating observed information comprises one or more of the following:
tracking information associated with tasks executed in the cluster;
tracking information associated with the states of nodes in the cluster; and
tracking information associated with network link usage and network transfers in the cluster.

7. The method of claim 6, wherein correlating observed information comprises tracking one or more of the following:
the number of tasks currently executing on the node;
the average expected execution time for each executing task on the node;
the average expected slowdown of each executing task if the data segment were to be transferred to the node;
the popularity of the data segment compared to other data segments stored by the node;
the popularity of the data segment compared to other data segments stored by the cluster; and
the average popularity of the data segments currently stored on the node.

8. The method of claim 7, wherein determining the slowdown and the predicted future benefit further comprises:
using a state vector to track information for a parameterized cost function that facilitates determining the slowdown and predicted future benefit for a replication decision; and
using values from the state vector as inputs to the parameterized cost function to predict whether replicating the data segment will lead to improved performance.

9. The method of claim 8, wherein the method further comprises using feedback from observed states and task slowdowns to update the parameters of the parameterized cost function, thereby more accurately predicting the expected future slowdowns of tasks on the node.

10. The method of claim 9, wherein the method further comprises updating the parameters of the parameterized cost function using a closed-loop feedback learning approach based on reinforcement learning that facilitates adaptively replicating data segments on the node.

11. A computer-readable storage medium storing instructions that when executed by a computer cause the computer to perform a method for determining whether to dynamically replicate data segments on a computing device, wherein the computing device operates as a node in a cluster of computing devices that collectively stores a collection of data segments, the method comprising:
identifying a data segment from the collection that is predicted to be frequently accessed by future tasks executing in the cluster;
determining a slowdown that would result for the current workload of the node if the data segment were to be replicated to the node;
determining a predicted future benefit associated with replicating the data segment to the node; and
replicating the data segment to the node when the slowdown is less than the predicted future benefit.

12. The computer-readable storage medium of claim 11, wherein identifying the data segment comprises determining high-demand data segments by tracking the data segments that are used by completed, executing, and queued tasks in the cluster.

13. The computer-readable storage medium of claim 11, wherein determining the slowdown and the predicted future benefit comprises correlating observed information from the cluster with task-execution times.

14. The computer-readable storage medium of claim 13, wherein determining the predicted future benefit involves comparing predicted task-execution times when the data segment is stored locally with predicted execution times when the data segment is stored remotely.

15. The computer-readable storage medium of claim 13, wherein correlating observed information comprises one or more of the following:
tracking information associated with tasks executed in the cluster;
tracking information associated with the states of nodes in the cluster; and
tracking information associated with network link usage and network transfers in the cluster.

16. The computer-readable storage medium of claim 15, wherein correlating observed information comprises tracking one or more of the following:
the number of tasks currently executing on the node;
the average expected execution time for each executing task on the node;
the average expected slowdown of each executing task if the data segment were to be transferred to the node;
the popularity of the data segment compared to other data segments stored by the node;
the popularity of the data segment compared to other data segments stored by the cluster; and
the average popularity of the data segments currently stored on the node.

17. The computer-readable storage medium of claim 16, wherein determining the slowdown and the predicted future benefit further comprises:
using a state vector to track information for a parameterized cost function that facilitates determining the slowdown and predicted future benefit for a replication decision; and
using values from the state vector as inputs to the parameterized cost function to predict whether replicating the data segment will lead to improved performance.

18. The computer-readable storage medium of claim 17, wherein the method further comprises using feedback from observed states and task slowdowns to update the parameters of the parameterized cost function, thereby more accurately predicting the expected future slowdowns of tasks on the node.

19. The computer-readable storage medium of claim 18, wherein the method further comprises updating the parameters of the parameterized cost function using a closed-loop feedback learning approach based on reinforcement learning that facilitates adaptively replicating data segments on the node.

20. A computing device that includes a processor that determines whether to dynamically replicate data segments, wherein the computing device operates as a node in a cluster of computing devices that collectively stores a collection of data segments, wherein the computing device comprises:
an identification mechanism configured to identify a data segment from the collection that is predicted to be frequently accessed by future tasks executing in the cluster;
a determining mechanism configured to determine a slowdown that would result for the current workload of the node if the data segment were to be replicated to the node;
wherein the determining mechanism is further configured to determine a predicted future benefit associated with replicating the data segment to the node; and
a replication mechanism that is configured to replicate the data segment to the node when the slowdown is less than the predicted future benefit.
